(19) United States
(12) Patent Application Publication
(10) Pub. No.: US 2024/0195866 A1
(43) Pub. Date: Jun. 13, 2024

(54) Distributed Computing in a Hosted Spreadsheet Application

(71) Applicant: Row Zero, Inc., Seattle, WA (US)

(72) Inventors: Grant B. Fresen, Seattle, WA (US); Nicholas End, Seattle, WA (US); Thomas Slatton, Seattle, WA (US); William Littlefield, San Francisco, CA (US)

(21) Appl. No.: 18/533,969

(22) Filed: Dec. 8, 2023

Related U.S. Application Data
(60) Provisional application No. 63/386,682, filed on Dec. 9, 2022.

(51) Int. Cl. H04L 67/1008

(52) U.S. Cl. CPC H04L 67/1008

(57) ABSTRACT

A system that runs a hosted spreadsheet application can trigger distributed computing to obtain additional computing support on-demand, when needed to assist with computationally intensive spreadsheet tasks or tasks that take too long to execute. The system will identify spreadsheet cells that each include a respective function that depends on the value of a different cell of the spreadsheet. The spreadsheet server will determine whether a task to be performed on the cells is a computationally heavy task. If the system cannot complete at least a threshold number of the functions before a threshold time period expires, or if the task is otherwise computationally intensive, the system will distribute at least some elements of the task to one or more additional computing devices for processing. The additional computing devices will return their results to a client device and/or an intermediate server.

### RELATED APPLICATIONS AND CLAIM OF PRIORITY

This patent document claims priority to U.S. Provisional Patent Application No. 63/386,682, filed Dec. 9, 2022, the disclosure of which is fully incorporated into this document by reference.

### BACKGROUND

A spreadsheet application can perform a wide variety of tasks, such as data ingestion, numeric calculations, data transformations and other actions. All such tasks require a combination of memory (such as that in random access memory (RAM)) and processing power (such as that of a central processing unit (CPU)), to complete. In most situations, these tasks are small or simple enough they are performed quickly. Occasionally, a user will ask a spreadsheet to perform a task, or a function stored in the spreadsheet that will require the spreadsheet to perform a task, that is computationally intensive, which can cause the spreadsheet to slow down, freeze until the computation is completed, or crash entirely.

This problem can be magnified when the spreadsheet is a hosted spreadsheet, in which some or all calculations are performed on a server that is remote from a client device that is displaying the spreadsheet data to a user. The longer that a calculation takes on the remote server, the more latency that the user of the client device may experience. This problem can even create conflicts between local and remote device data if the user enters data into a cell or changes a cell's formula at the client device while the remote server is acting on a previous version of the data or formula.

This document describes methods and systems that are directed to solving the problems described above.

### SUMMARY

This document describes a method of hosting a spreadsheet, systems including computing devices that can implement the method, and computer program products having programming instructions that are configured to implement the method.

In this method, a processor of a first computing device will cause a display device to display a spreadsheet containing various cells. Each cell is associated with a corresponding value or function. The system will identify a subset of the cells that each have a respective function that includes a variable that depends on the value of a different cell of the spreadsheet. The system may assess a task to be performed on the cells to determine whether the task the cells will qualify as a computationally heavy task. If the system otherwise determines that the task is a computationally heavy task, the system will distribute at least a portion of the task to one or more additional computing devices to process one or more elements of the task. When the system receives, from each of the other computing devices, results that include values for the cells, the system causes the display device to display the values for the cells of the first subset and the values of the cells of the additional subsets in their corresponding cells

In some embodiments, determining that the task is a computationally heavy task may comprise (a) processing the functions of the cells of the first subset to yield updated values for the cells of the first subset, and (b) identifying that processing of the functions has not completed for a threshold number of the cells of the first subset before a threshold time period expires. Then, distributing at least a portion of the tasks to one or more additional computing devices may comprise (a) assigning cells that have not yet been processed to one or more additional subsets, and (b) distributing each of the additional subsets to the one or more additional computing devices to process the functions of the cells of the one or more additional subsets. Receiving the results that include values for one or more of the cells may comprise receiving, from each of the one or more additional computing devices, results that include values for one or more of the cells of the one or more additional subsets.

Optionally, assigning the cells that have not yet been processed to the one or more additional subsets may comprise (a) identifying a number of the additional computing devices that are available to support processing the additional subsets, and (b) dividing the cells that have not yet been processed into a number of subsets that equals the number of the additional computing devices.

Optionally, assigning the cells that have not yet been processed into the one or more additional subsets may comprise: (a) identifying a first set of one or more of additional computing devices and a second set of one or more of the additional computing devices, wherein the computing devices of the first set have relatively higher computing capacity than the computing devices of the second set; (b) assigning additional cells having relatively more complex tasks to the computing devices of the first set; and (c) assigning additional cells that have relatively less complex tasks to the computing devices of the second set.

In some embodiments, determining that the task is a computationally heavy task may comprise identifying that the task is associated with a category of defined computationally heavy tasks.

In some embodiments, identifying the first subset of the cells may comprise using a directed acyclic graph to identify cells that have dependencies on other cells.

In some embodiments, the first computing device may have less random access memory, less processing capacity, or both than each of the one or more additional computing devices.

### BRIEF DESCRIPTION OF THE DRAWINGS

FIG. 1 illustrates an example of a spreadsheet application that includes computationally heavy functions.

FIG. 2 illustrates elements of a system, including a local computing device, a main remote server, and several auxiliary remote servers.

FIG. 3 a process by which a system may perform distributed computing for a hosted spreadsheet.

FIG. 4 illustrates an example of a directed acyclic graph that a spreadsheet may use.

FIG. 5 illustrates components of an example computing device that can perform the various functions described in this document.

### DETAILED DESCRIPTION

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” (or “comprises”) means “including (or includes), but not limited to.”

In this document, when terms such as “first” and “second” are used to modify a noun, such use is simply intended to distinguish one item from another, and is not intended to require a sequential order unless specifically stated. The term “approximately,” when used in connection with a numeric value, is intended to include values that are close to, but not exactly, the number. For example, in some embodiments, the term “approximately” may include values that are within +/−10 percent of the value.

As used in this document, the term “computationally intensive”, when referring to a task that a computing device is asked to complete, refers to a task for which the run time and/or computation requirements (such as processing demands or volatile memory requirements) exceed a threshold that is typically high and near the capacity of the memory and/or processing devices of the computing device. For example, a process in which run time increases exponentially, or which is proportional to the square of the number of values to be processed by the task, may be considered to be computationally intensive.

In this document the terms “formula” and “function”, when used in reference to a spreadsheet cell, or describe an equation or calculation that is defined by the contents of the spreadsheet cell. Although in the art such terms may have a subtle distinction in that formulas are typically defined by users and functions are typically pre-defined by the spreadsheet application. However, in this document, unless the relevant description assigns a particular meaning the terms are intended to interchangeably refer to any equation that a cell contains or implements, whether pre-defined or defined by a user.

Additional terms that are relevant to this disclosure will be defined at the end of this Detailed Description section.

As described in the Background section above, when a spreadsheet attempts to perform a task that is computationally intensive, it can cause the spreadsheet to slow down, freeze until the computation is completed, or crash entirely. When a computationally intensive task is run over a small data set, the effects described above may be minimal. However, when a computationally intensive task is run over a medium- to large-sized data set, the run time may grow with the square of the number of rows or worse, higher exponential powers, depending on the nature of the functions, and the effects described above will be noticeable to the user and/or crippling to the functioning of the spreadsheet.

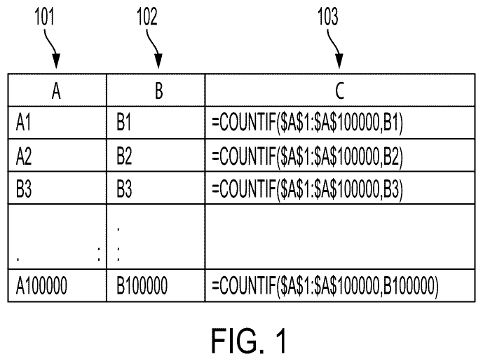

As an example, consider the spreadsheet of FIG. 1, which includes 100,000 values in each of Column A 101 and Column B 102. Column C 103 is a computed column in which each cell includes a function that asks the spreadsheet application to take the value in the cell's corresponding Column B row and compare that value to every value in Column A, counting the number of times the value in B #occurs in column A. For example, Row 1 of Column C 103 has the function=COUNTIF($A$1:$A$100000,B1). Filling that function down into every row of Column C 103 asks the program to perform a task over every row of column A 101 for every row in column B 102. This is an example of a computationally intensive task.

In a normal spreadsheet running locally on one machine, the compute power of the spreadsheet is limited to the amount of random access memory (RAM) or other type of volatile memory and processing capability on the machine. Some processors have multiple cores, which can be used to parallelize computationally heavy actions on one machine. However, even those types of processors are insufficient to perform certain tasks over hundreds of thousands or millions of rows. When given a computationally heavy task, a local computing device has a limited amount of processing power and memory to use for the computation. Thus, the computations will take a very long time to complete, or they may crash the program altogether.

Methods and systems for hosting a spreadsheet in a cloud-based system are known. For example, U.S. Provisional Patent Application No. 63/378,694, filed Oct. 7, 2022, the disclosure of which is fully incorporated by reference, describes such a system. In one embodiment described in that patent application, a processor of a local computing device executes programming instructions that cause the local computing device to implement a spreadsheet application by: (i) displaying a user interface comprising a spreadsheet containing a multiple cells; (ii) identifying a remote server that contains an active instance of the spreadsheet; (iii) receiving, from the remote server for each of the cells, a corresponding value to display in that cell; and (iv) displaying, in each of the cells, the corresponding value as received from the remote server without the local computing device performing any function to calculate the corresponding value. Instead, all calculations are done on the remote computing device. In another embodiment described in that patent application, a user of the spreadsheet can selectively choose a selection of a local operation mode or a remote operation mode. The local computing device will perform the calculations if the user selects the local operation mode; the remote computing device will perform the calculations if the user selects the remote operation mode.

When a spreadsheet application is implemented by a cloud-based system or a hybrid local and cloud-based system as described above, the spreadsheet's values are displayed on a local computing device, while calculation of those values is (at least sometimes) performed on a server that is remote from the local computing device. While hosted spreadsheets will typically operate on servers with more processing capacity (such as through the use of improved processing devices, multiple processors, and/or processors having multiple cores) and more RAM than is available on the local computing device, even remote servers can slow down or crash if a computationally heavy task is large enough.

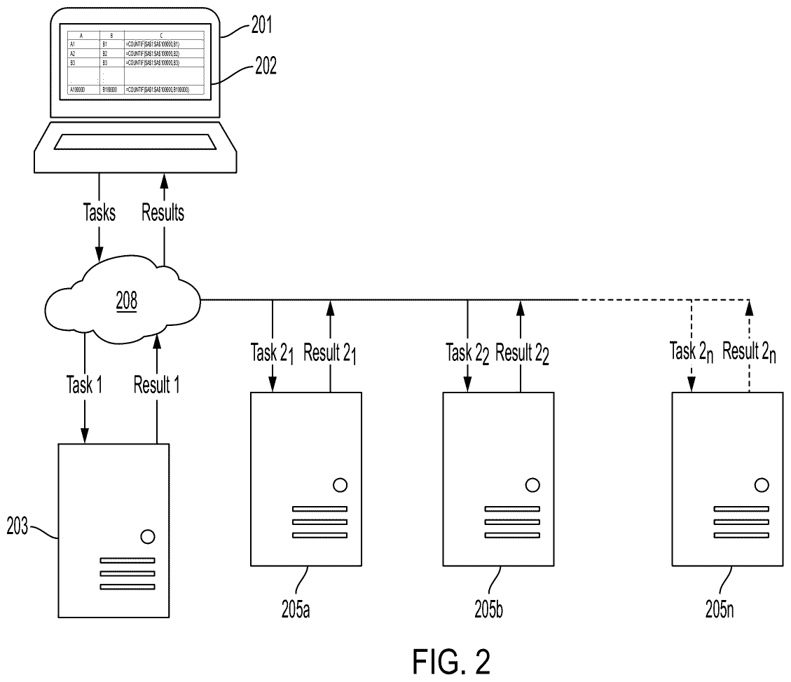

To address this issue, this document describes a method and system that includes or involves elements such as those shown in FIG. 2. In FIG. 2, a local device 201 includes a display device that is displaying a user interface of a spreadsheet application 202 in a local instance of the application, a browser or another client-side application. A first remote computing device 203 also hosts an instance of the spreadsheet application, and the remote computing device performs at least some of the computations that are required to complete functions and assign values to the cells that local computing device 201 will display. This document may refer to the first remote computing device 203 as a spreadsheet server. The local computing device 201 and the spreadsheet server 203 are communicatively connected to each other via one or more networks 208. The spreadsheet server 203 that hosts the spreadsheet application 202, the local computing device 201, or both devices are programmed to detect when the spreadsheet application 202 requires a computationally heavy task, using processes such as those that will be described below.

If the system detects a computationally heavy task, the local computing device 201 and/or the spreadsheet server 203 can automatically share the computation load with any of several other computing devices 205a . . . 205n that are communicatively connected to the system via one or more networks 208. (This document may generally use reference number 205 to refer to any or all of the additional computing devices 205a . . . 205n.) The local computing device 201 and/or spreadsheet server 203 will then distribute the computational load across one or more of the additional computing devices 205, thus dividing the work into smaller chunks and allowing the chunks to execute simultaneously on multiple nodes.

For example, as shown in FIG. 2 the spreadsheet server 203, acting as a first computing device, may perform a first task, but it may distribute various elements of a second task to one or more of the additional computing devices 205. The additional computing devices 205 are nodes of a remote system that collectively receive the tasks, execute the tasks to calculate values for the cells of the spreadsheet 202, and return the calculated values as results to the first computing device 203 (in its capacity as the primary spreadsheet server) and/or the local computing device 201 for display by the spreadsheet application 202. The result is a system that may complete computationally heavy tasks exponentially faster than mere locally hosted spreadsheet applications, and also faster than existing server-hosted spreadsheet applications.

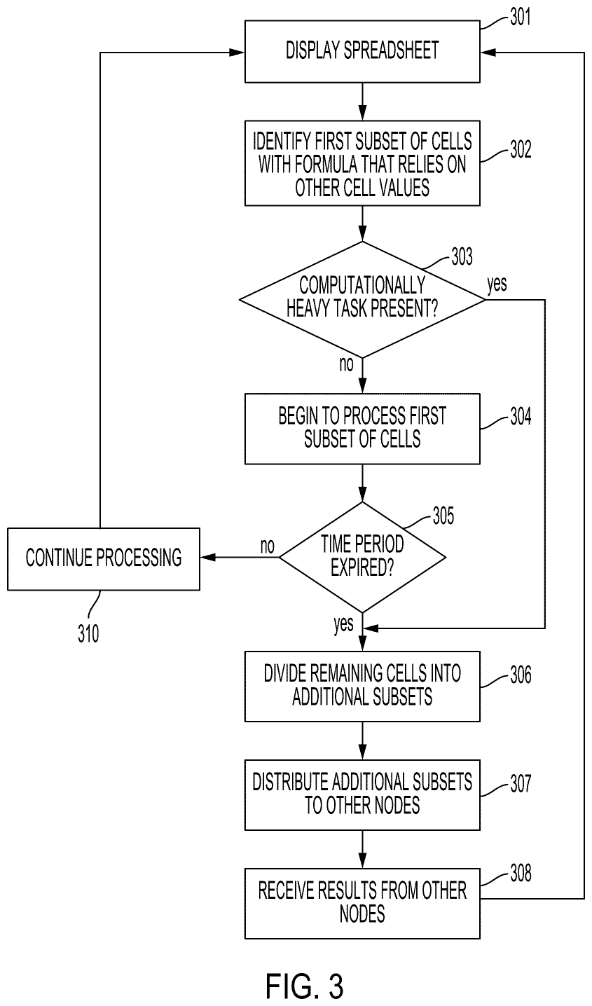

FIG. 3 illustrates a process by which the system may perform the functions described above. At 301 a local computing device that is operated by a user may use a spreadsheet application to display a spreadsheet on a user's device. At 302 a remote computing device or the local computing device will identify a subset of the cells that each include a respective formula that includes a variable that depends on the value of a different cell of the spreadsheet. An example of such a subset is found in the rows of Column C 103 of FIG. 1.

Before beginning to process at least some the formula(s) in the cells, at 303 the system will identify a task to be performed on the subset of cells and determine whether the task qualifies as a computationally heavy task. For example, at 303 the system may examine the formula(s) and/or the subset of cells to determine whether the formula(s) and/or cells will satisfy a condition that qualifies the subset of cells as requiring a computationally heavy task. For example, if the number of cells in the subset exceeds a threshold value, the task to be implemented by processing the formulas of the subset of cells may qualify as a computationally heavy task. Other conditions that may qualify a subset of cells as requiring a computationally heavy task include, without limitation, any of (or combinations of) the following: (i) whether the cells contain a function of a type that is predetermined to be computationally intensive; (ii) whether, based on historical data, the cells contain functions, data set sizes, or both that the system previously determined to be computationally intensive; (iii) whether one or more default conditions, one or more conditions that are associated with a profile or account of a user of the spreadsheet is occurring, or whether one or more conditions specified by the user are occurring.

Other actions that can be considered to be computationally heavy tasks in step 303 may include tasks that are associated with one or more categories of tasks that the system has pre-defined as memory-intensive tasks. Examples of such tasks may include, for example, importing data from an external source, processing a pivot table, generating a graph with at least a threshold amount of data or number of data series, conditional formatting across data sets that exceed a threshold size, and other defined actions. The system may be programmed with a list or other data set of tasks that are to be considered computationally heavy in all situations, or which qualify as computationally heavy when certain conditions are satisfied (such as size of the data set on which the task will be performed exceeding a threshold). Other conditions may include a requirement that a threshold level of compute power be available to perform the task. In addition, the parameters of any of the conditions described above may be adjusted based on the compute power available, based on the spreadsheet node (which may host more than one workbook), or based on other available nodes to which the system may decide to distribute the computations.

If no computationally heavy task is identified at 303, or if the system does not perform step 303, then at 304 the remote computing device (i.e., the spreadsheet server, acting as a workbook node of a system including multiple nodes) will begin to process the formulas of a first subset of the additional cells to yield updated values for the cells of the first subset. The spreadsheet server will continue do to this until it either completes the task or a threshold time period passes. If no computationally heavy task is present (303: NO) and/or the system can process the formulas for a threshold number of the cells before a threshold time period expires (305: NO), then the spreadsheet server may continue to execute other tasks of the spreadsheet 310.

However, if either the system determines that a computationally heavy task is present (303: YES) or the time period expires before the system completed processing the formulas for the threshold number of the cells (304: YES), then at 306 the spreadsheet server may presume that a computationally heavy task is present and divide the cells that have not yet been processed into any number of additional subsets. At 307 the spreadsheet server will distribute each of the additional subsets among any number of the other nodes (i.e., other remote computing devices of the system) to process the formulas of cells of the additional subsets.

At 308 the spreadsheet server will receive, from each of the other computing devices, results that include values for one or more of the cells of the additional subsets. After all of the calculations are complete, the spreadsheet server will return these values to the local computing device, which will cause the local computing device to display the values in the cells of its spreadsheet (thus returning to step 301).

As noted above, at 302 the system will identify a first subset of the cells having formulas that rely on values of other cells. The system may use any suitable method of doing this. For example, a spreadsheet data file typically represents cells having values that rely on other cells' values in the form of a directed acyclic graph (DAG). Any cell that is represented in the DAG will qualify to be in the first subset. The system may select all cells represented in the DAG for the first subset, or only a subset of them.

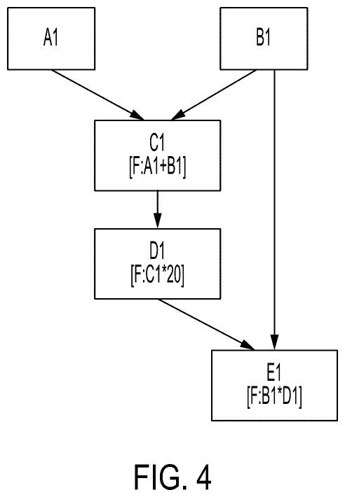

An example of a very simple DAG for a spreadsheet application is shown in FIG. 4. In FIG. 4, cells A1 and B1 each have corresponding values. Cell C1 includes a function that is the sum of the values of cells A1 and B1. Cell D1 includes the function C1*20. Cell E1 includes the function B1*D1. In this DAG, cells A1 through D1 would not require any computationally intensive tasks. Cell E1 starts to get more complex since the value of cell A1 will influence the result of E1's formula, even though A1 is not directly part of cell E1's function, because the result of E1 relies on the result of D1 which in turn relies on the value of A1. However, a DAG that requires computationally intensive tasks would typically be much denser and more detailed that that shown in FIG. 4.

In the example of FIG. 4, cells C1, D1 and E1 all have formulas that rely on the values of other cells. Cells A1 and B1 simply hold values and do not depend on any other cells, and thus would not be considered as candidates for computationally intensive tasks.

Also as noted above in FIG. 3, at 306 the spreadsheet server may divide the cells that that have not yet been processed into any number of additional subsets, and at 307 the spreadsheet server will distribute each of the additional subsets among any number of other computing devices (nodes) to process the formulas of cells of the additional subsets. The system may use any suitable methods for doing this. For example, if the system knows that a number N of additional servers are available to support the tasks, the system may divide the remaining cells into N subsets of approximately equal size, and the system may distribute the N subsets among the N other computing devices. The system may simply assign the subsets to the other computing devices in sequence, or it may prioritize the assignments using any suitable rule sets. In addition, in some embodiments if the system knows that certain nodes have greater computing capacity (i.e., processing capability/speed and/or volatile memory) than other nodes, the system may assign relatively more complex (i.e., more computationally heavy) tasks to the nodes that have relatively higher computing capacity and less complex tasks to the nodes with lesser computing capacity. By way of example, the system may assign more complex tasks to nodes having graphics processing units (GPUs) and/or a higher amount of RAM, and it may assign and less complex tasks to nodes having only central processing units (CPUs) and no GPUs and/or a relatively lower amount of RAM.

In some embodiments, the spreadsheet server (first computing device 203 of FIG. 1) may have relatively less RAM or processing power than that of the other remote computing devices, so that most processing is performed on a relatively low-cost and less power-consuming device (the spreadsheet server 203), and the more powerful servers (the additional remote computing devices 205) are only activated and accessed when needed. Optionally the processing power and/or volatile memory of the additional computing devices may vary between the devices. For example and without limiting the invention to any particular type of device, the first computing device 203 may have 2 GB of RAM, additional computing device 205a may have 8 GB of RAM, additional computing device 205b may have 16 GB of RAM, and additional computing device 205c may have 32 GB of RAM. In some embodiments, the system may simply assign all cells of a spreadsheet to one of the additional computing devices. Alternatively, the system may determine a value of computational complexity for each of the cells or groups of the cells, and it may assign cells having relatively more complex tasks to a first additional computing device (or devices) that has (or have) relatively more memory or processing power than a second additional computing device (or devices), and the system may assign cells that have relatively less complex tasks to the second additional computing device(s). In addition, as noted earlier in some embodiments particular categories of tasks may be considered to be computationally heavy. Such tasks may include, for example, importing data, processing pivot tables or performing conditional formatting or graph generation on large data sets. The system may assign all such tasks to a relatively more powerful computing device.

By distributing computationally heavy tasks among multiple computing devices, the system and methods described in this document can help solve issues of latency that may result in hosted and/or local spreadsheet operations. The systems and methods can also help reserve computing capacity of more powerful (and more expensive) processing devices for tasks that require such capacity, while implementing lower intensity tasks on relatively less expensive devices.

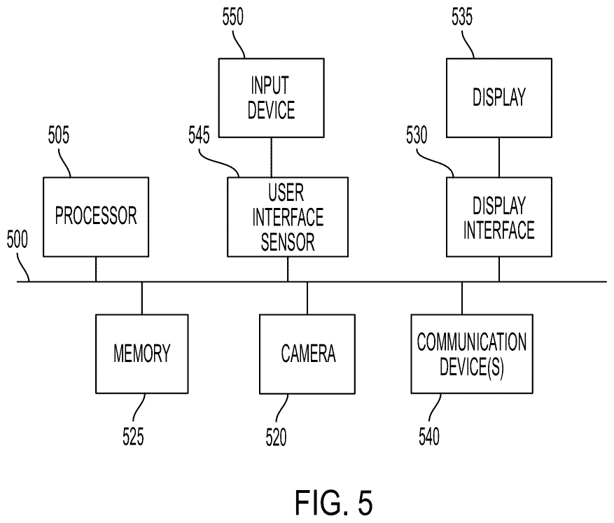

FIG. 5 depicts an example of internal hardware that may be included in any of the electronic components of the system, such as the user's smartphone or a local or remote computing device in the system. An electrical bus 500 serves as a communication path via which messages, instructions, data, or other information may be shared among the other illustrated components of the hardware. Processor 505 is a central processing device of the system, configured to perform calculations and logic operations required to execute programming instructions. As used in this document and in the claims, the terms “processor” and “processing device” may refer to a single processor or any number of processors in a set of processors that collectively perform a set of operations, such as a central processing unit (CPU), a graphics processing unit (GPU), a remote server, or a combination of these. Read only memory (ROM), random access memory (RAM), flash memory, hard drives and other devices capable of storing electronic data constitute examples of memory devices 525. A memory device may include a single device or a collection of devices across which data and/or instructions are stored.

An optional display interface 530 may permit information from the bus 500 to be displayed on a display device 535 in visual, graphic or alphanumeric format. An audio interface and audio output (such as a speaker) also may be provided. Communication with external devices may occur using various communication devices 540 such as a wireless antenna, a radio frequency identification (RFID) tag and/or short-range or near-field communication transceiver, each of which may optionally communicatively connect with other components of the device via one or more communication systems. The communication device 540 may be configured to be communicatively connected to a communications network, such as the Internet, a local area network or a cellular telephone data network.

The hardware may also include a user interface sensor 545 that allows for receipt of data from input devices 550 such as a keyboard, a mouse, a joystick, a touchscreen, a touch pad, a remote control, a pointing device and/or microphone. Digital image frames also may be received from a camera 520 that can capture video and/or still images.

Based on the teachings contained in this disclosure, it will be apparent to persons skilled in the relevant art(s) how to make and use embodiments of this disclosure using data processing devices, computer systems and/or computer architectures other than that shown in FIG. 5. In particular, embodiments can operate with software, hardware, and/or operating system implementations other than those described in this document.

Terminology that is relevant to this disclosure includes:

The term “computing device” refers to a device or system that includes a processor and memory. Each computing device may have its own processor and/or memory, or the processor and/or memory may be shared with other devices as in a virtual machine or container arrangement. The memory will contain or receive programming instructions that, when executed by the processor, cause the computing device to perform one or more operations according to the programming instructions. Examples of computing devices include personal computers, servers, mainframes, virtual machines, containers, gaming systems, televisions, digital home assistants and mobile electronic devices such as smartphones, fitness tracking devices, wearable virtual reality devices, Internet-connected wearables such as smart watches and smart eyewear, personal digital assistants, cameras, tablet computers, laptop computers, media players and the like. computing devices also may include appliances and other devices that can communicate in an Internet-of-things arrangement, such as smart thermostats, refrigerators, connected light bulbs and other devices. Computing devices also may include components of vehicles such as dashboard entertainment and navigation systems, as well as on-board vehicle diagnostic and operation systems. In a client-server arrangement, the client device and the server are both computing devices, in which the server contains instructions and/or data that the client device accesses via one or more communications links in one or more communications networks. In a virtual machine arrangement, a server may be a computing device, and each virtual machine or container also may be considered a computing device. In the discussion above, a client device, server device, virtual machine or container may be referred to simply as a “device” for brevity. Additional elements that may be included in computing devices are discussed above in the context of FIG. 5.

The terms “processor” and “processing device” refer to a hardware component of an electronic device that is configured to execute programming instructions. Except where specifically stated otherwise, the singular terms “processor” and “processing device” are intended to include both single-processing device embodiments and embodiments in which multiple processing devices together or collectively perform a process.

The terms “memory,” “memory device,” “computer-readable medium,” “data store,” “data storage facility” and the like each refer to a non-transitory device on which computer-readable data, programming instructions or both are stored. Except where specifically stated otherwise, the terms “memory,” “memory device,” “computer-readable medium,” “data store,” “data storage facility” and the like are intended to include single device embodiments, embodiments in which multiple memory devices together or collectively store a set of data or instructions, as well as individual sectors within such devices. A computer program product is a memory device with programming instructions stored on it.

In this document, the terms “communication link” and “communication path” mean a wired or wireless path via which a first device sends communication signals to and/or receives communication signals from one or more other devices. Devices are “communicatively connected” if the devices are able to send and/or receive data via a communication link. “Electronic communication” refers to the transmission of data via one or more signals between two or more electronic devices, whether through a wired or wireless network, and whether directly or indirectly via one or more intermediary devices. The network may include or is configured to include any now or hereafter known communication networks such as, without limitation, a BLUETOOTH® communication network, a Z-Wave® communication network, a wireless fidelity (Wi-Fi) communication network, a ZigBee communication network, a HomePlug communication network, a Power-line Communication (PLC) communication network, a message queue telemetry transport (MQTT) communication network, a MTConnect communication network, a cellular network a constrained application protocol (CoAP) communication network, a representative state transfer application protocol interface (REST API) communication network, an extensible messaging and presence protocol (XMPP) communication network, a cellular communications network, any similar communication networks, or any combination thereof for sending and receiving data. As such, network 204 may be configured to implement wireless or wired communication through cellular networks, WiFi, BlueTooth, Zigbee, RFID, BlueTooth low energy, NFC, IEEE 802.11, IEEE 802.15, IEEE 802.16, Z-Wave, Home Plug, global system for mobile (GSM), general packet radio service (GPRS), enhanced data rates for GSM evolution (EDGE), code division multiple access (CDMA), universal mobile telecommunications system (UMTS), long-term evolution (LTE), LTE-advanced (LTE-A), MQTT, MTConnect, CoAP, REST API, XMPP, or another suitable wired and/or wireless communication method. The network may include one or more switches and/or routers, including wireless routers that connect the wireless communication channels with other wired networks (e.g., the Internet). The data communicated in the network may include data communicated via short messaging service (SMS), multimedia messaging service (MMS), hypertext transfer protocol (HTTP), direct data connection, wireless application protocol (WAP), e-mail, smart energy profile (SEP), ECHONET Lite, OpenADR, MTConnect protocol, or any other protocol.

When used in this document, terms such as “top” and “bottom,” “upper” and “lower”, or “front” and “rear,” are not intended to have absolute orientations but are instead intended to describe relative positions of various components with respect to each other. For example, a first component may be an “upper” component and a second component may be a “lower” component when a device of which the components are a part is oriented in a first direction. The relative orientations of the components may be reversed, or the components may be on the same plane, if the orientation of the structure that contains the components is changed. The claims are intended to include all orientations of a device containing such components.

While this disclosure describes example embodiments for example fields and applications, it should be understood that the disclosure is not limited to the disclosed examples. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described in this document. Further, embodiments (whether or not explicitly described) have significant utility to fields and applications beyond the examples described in this document.

The features from different embodiments disclosed in this document may be freely combined. For example, one or more features from a method embodiment may be combined with any of the system or product embodiments. Similarly, features from a system or product embodiment may be combined with any of the method embodiments herein disclosed. This, references in this document to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described in this document.

As described above, this document discloses system, method, and computer program product embodiments for distributed computing in a hosted spreadsheet application. The system embodiments include a local computing device, which may have access to one or more remote computing devices. In some embodiments, one or more of the remote computing devices also may be part of the system. The computer program embodiments include programming instructions, stored in a memory device, that are configured to cause a processor to perform the methods described in this document.

This document incorporates by reference the full disclosure of U.S. patent application Ser. No. 18/482,751, filed Oct. 6, 2023.

1. A method comprising, by a processor of a first computing device:
causing a display device to display a spreadsheet containing a plurality of cells, wherein each cell is associated with a corresponding value or function;
identifying a first subset of the cells that each include a respective function that includes a variable that depends on the value of a different cell of the spreadsheet;
identifying a task to be performed on the first subset of the cells;
in response to determining that the task is a computationally heavy task, distributing at least a portion of the task to one or more additional computing devices;
receiving, from each of the one or more additional computing devices, results that include values for one or more of the cells, and
causing the display device to display the values for the one or more cells in their corresponding cells.

2. The method of claim 1, wherein:
determining that the task is a computationally heavy task comprises:
processing the functions of the cells of the first subset to yield updated values for the cells of the first subset, and
identifying that processing of the functions has not completed for a threshold number of the cells of the first subset before a threshold time period expires;
distributing at least a portion of the tasks to one or more additional computing devices comprises:
assigning cells that have not yet been processed to one or more additional subsets,
distributing each of the additional subsets to the one or more additional computing devices to process the functions of the cells of the one or more additional subsets; and
receiving the results that include values for one or more of the cells comprises receiving, from each of the one or more additional computing devices, results that include values for one or more the cells of the one or more additional subsets.

3. The method of claim 1, wherein determining that the task is a computationally heavy task comprises identifying that the task is associated with a category of defined computationally heavy tasks.

4. The method of claim 1, wherein identifying the first subset of the cells comprises using a directed acyclic graph to identify cells that have dependencies on other cells.

5. The method of claim 2, wherein assigning the cells that have not yet been processed to the one or more additional subsets comprises:
identifying a number of the additional computing devices that are available to support processing the additional subsets; and
dividing the cells that have not yet been processed into a number of subsets that equals the number of the additional computing devices.

6. The method of claim 2, wherein assigning the cells that have not yet been processed into the one or more additional subsets comprises:
identifying a first set of one or more of additional computing devices and a second set of one or more of the additional computing devices, wherein the computing devices of the first set have relatively higher computing capacity than the computing devices of the second set;
assigning additional cells having relatively more complex tasks to the computing devices of the first set; and
assigning additional cells that have relatively less complex tasks to the computing devices of the second set.

7. The method of claim 1, wherein the first computing device has less random access memory, less processing capacity, or both than each of the one or more additional computing devices.

8. A method comprising, by a processor of a first computing device:
causing a display device to display a spreadsheet containing a plurality of cells, wherein each cell is associated with a corresponding value or function;
identifying a first subset of the cells that each include a respective function that includes a variable that depends on the value of a different cell of the spreadsheet; and
in response to determining that the functions of cells of the first subset will require a computationally heavy task:
assigning at least some cells that have not yet been processed to one or more additional subsets,
distributing each of the one or more additional subsets among one or more additional computing devices to process the functions of cells of the additional subsets,
receiving, from each of the one or more additional computing devices, results that include values for one or more the cells of the additional subsets, and
causing the display device to display the values for the cells of the first subset and the values of the cells of the additional subsets in their corresponding cells.

9. The method of claim 8, wherein identifying the cells of the first subset comprises using a directed acyclic graph to identify cells that have dependencies on other cells.

10. The method of claim 1, wherein determining that the functions of cells of the first subset will require a computationally heavy task comprises identifying that the functions are associated with a category of defined computationally heavy tasks.

11. The method of claim 8, wherein assigning the cells that have not yet been processed into the one or more additional subsets comprises:
identifying a number of the additional computing devices that are available to support processing the one or more additional subsets; and
dividing the cells that have not yet been processed into a number of subsets that equals the number of the additional computing devices.

12. The method of claim 8, wherein assigning the cells that have not yet been processed into the one or more additional subsets comprises:
identifying a first set of one or more of additional computing devices and a second set of one or more of the additional computing devices, wherein the computing devices of the first set have relatively higher computing capacity than the computing devices of the second set;
assigning cells having relatively more complex tasks to the computing devices of the first set; and
assigning cells that have relatively less complex tasks to the computing devices of the second set.

13. The method of claim 8, wherein the first computing device has less random access memory, less processing capacity, or both than each of the additional computing devices.

14. The method of claim 8, further comprising determining that the functions of the cells of the first subset will require a computationally heavy task in response to the number of cells in the first subset exceeding a threshold value.

15. A system comprising:
a first computing device;
one or more additional computing devices; and
a memory that is part of or remote from the first computing device, the memory containing programming instructions that are configured to, when executed by the first computing device:
cause a display device to display a spreadsheet containing a plurality of cells, wherein each cell is associated with a corresponding value or function,
identify a first subset of the cells that each include a respective function that includes a variable that depends on the value of a different cell of the spreadsheet; and
in response to determining that a task to be performed on the first subset of the cells is a computationally heavy task:
assign at least some cells that have not yet been processed to one or more additional subsets;
distribute each of the cells of the one or more additional subsets among one or more of the additional computing devices to process the functions of cells of the additional subsets;
upon receiving, from the one or more other computing devices to which cells were distributed, results that include values for one or more the cells of the additional subsets, cause the display device to display the values for the cells of the first subset and the values of the cells of the additional subsets in their corresponding cells.

16. The system of claim 15, further comprising instructions to determine that the task is a computationally heavy task in response to determining that:
the task is associated with a category that is defined as computationally heavy;
the functions of cells of the first subset will require a computationally heavy task; or
the processing of the functions is not completed for a threshold number of the cells of the first subset before a threshold time period expires.

17. The system of claim 15, wherein the first computing device has less random access memory, less processing capacity, or both than each of the additional computing devices.

18. The system of claim 15, further comprising instructions to determine that the functions of the cells of the first subset will require a computationally heavy task when the number of cells in the first subset exceeds a threshold value.

19. The system of claim 15, wherein the instructions to identify the cells of the first subset comprise instructions to use a directed acyclic graph to identify cells that have dependencies on other cells.

20. The system of claim 15, wherein the instructions to assign the cells that have not yet been processed into the one or more additional subsets comprise instructions to:
identify a number of the additional computing devices that are available to support processing the one or more additional subsets; and
divide the cells that have not yet been processed into a number of subsets that equals the number of the additional computing devices.

21. The system of claim 20, wherein the instructions to assign the cells that have not yet been processed into the one or more additional subsets comprise instructions to:
identify a first set of one or more of additional computing devices and a second set of one or more of the additional computing devices, wherein the computing devices of the first set have relatively higher computing capacity than the computing devices of the second set;
assign cells having relatively more complex tasks to the computing devices of the first set; and
assign cells that have relatively less complex tasks to the computing devices of the second set.
